(19) United States
(12) Patent Application Publication
(10) Pub. No.: US 2022/0084420 A1
(43) Pub. Date: Mar. 17, 2022

(54) VIRTUAL HAZARD SURVEY AND RISK BASED DYNAMIC FLIGHT PLANNING

(71) Applicant: GE Aviation Systems LLC, Grand Rapids, MI (US)

(72) Inventors: Szabolcs A. Borgyos, Grand Rapids, MI (US); Adam J. Diffenderfer, Grand Rapids, MI (US)

(73) Assignee: GE Aviation Systems LLC, Grand Rapids, MI (US)

(21) Appl. No.: 17/020,031

(22) Filed: Sep. 14, 2020

(51) Int. Cl. G08G 5/00

(52) U.S. Cl. CPC G08G 5/0069; G08G 5/0034

(57) ABSTRACT

A method of determining a flight plan for an unmanned aerial vehicle comprises, with a computing device, receiving a set of parameters associated with a proposed flight operation related to the unmanned aerial vehicle, identifying one or more data sources that contain data associated with one or more of the parameters, retrieving data associated with one or more of the parameters from one or more of the identified data sources, determining a level of risk associated with the proposed flight operation based on the retrieved data, and determining the flight plan based on the level of risk.

### FIELD

The present disclosure relates to devices, systems, and methods for preparing safety cases, and more specifically, for virtual hazard survey and risk-based dynamic flight planning.

### BACKGROUND

Air traffic is often regulated to ensure safe and equitable access to airspace, and to reserve or protect certain airspace, for example for specific uses. Such regulation may be informal or formal (e.g., promulgated by a governmental or other official authority). For instance, the Federal Aviation Administration (FAA) promulgates rules that regulate air traffic in the United States. In particular, Part 107 of the Federal Aviation Regulations covers rules for drones weighing less than 55 pounds. In general, these rules require drones to be kept within a line a line of sight of a drone operator and prohibit drones from being flown at night or over people not participating in the drone operation. Other rules set a maximum speed and elevation, limit payloads, and establish other restrictions and requirements. However, the FAA allows drone operators to apply for a waiver of most of these operational restrictions.

In order to be granted a waiver, a drone operator must show that a proposed operation can be conducted safely. This requires preparing a safety case and submitting it to the FAA. A safety case generally comprises an identification of all potential hazards in the environment of a proposed drone operation and levels of risk associated with each hazard. A safety case may also comprise operational procedures, performance specifications, and equipment to be used to mitigate risks. A safety case may be submitted to the FAA with a request for a waiver and the FAA may determine whether to grant the requested waiver. If the waiver is granted, the drone operation may proceed under the conditions set by the FAA (e.g., with certain limitations or required safety procedures place).

To prepare a safety case, a drone operator may be required to gather a large amount of environmental and other data related to the potential drone operation. This may require significant time and expense, as this data is typically gathered manually. In addition, the gathered data is not generally tailored to the dynamic nature of an operation (e.g., particular days or times when an operation may be performed). As such, there is a need for an improved method of gathering data and preparing a safety case.

### SUMMARY

In an embodiment, a method of determining a flight plan for an unmanned aerial vehicle includes, with a computing device, receiving a set of parameters associated with a proposed flight operation related to the unmanned aerial vehicle, identifying one or more data sources that contain data associated with one or more of the parameters, retrieving data associated with one or more of the parameters from one or more of the identified data sources, determining a level of risk associated with the proposed flight operation based on the retrieved data, and determining the flight plan based on the level of risk.

In an embodiment, a remote computing device includes one or more processors, one or more memory modules, and machine-readable instructions stored in the one or more memory modules. When executed by the one or more processors, the machine-readable instructions cause the remote computing device to receive a set of parameters associated with a proposed flight operation related to an unmanned aerial vehicle, identify one or more data sources that contain data associated with one or more of the parameters, retrieve data associated with one or more of the parameters from one or more of the identified data sources, determine a level of risk associated with the proposed flight operation based on the retrieved data, and determine a flight plan for the unmanned aerial vehicle based on the level of risk.

In an embodiment, a system includes a safety case generation unit and a traffic management system. The safety case generation unit is configured to receive a set of parameters associated with a proposed flight operation for an aerial vehicle, identify one or more data sources that contain data associated with one or more of the parameters, retrieve data associated with one or more of the parameters from one or more of the identified data sources, determine a level of risk associated with the proposed flight operation based on the retrieved data, and determine a flight plan for the aerial vehicle based on the level of risk. The traffic management system is configured to monitor the aerial vehicle.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 schematically depicts an exemplary system for performing a flight operation for a drone, according to one or more embodiments shown and described herein;

FIG. 2 schematically depicts an example safety case generation unit 110, according to one or more embodiments shown and described herein;

FIG. 3 schematically depicts an example unmanned traffic management system, according to one or more embodiments shown and described herein;

FIG. 4 depicts a flow chart of an illustrative method of generating a safety case, according to one or more embodiments shown and described herein; and

FIG. 5 depicts a flow chart for monitoring an unmanned aerial vehicle, according to one or more embodiments shown and described.

### DETAILED DESCRIPTION

The present disclosure generally relates to devices, systems, and methods for preparing a safety case relating to a drone operation, which may be submitted to an informal or formal regulator such as the FAA, as part of a waiver application. As used herein, a safety case may comprise operational details of a proposed flight operation and any mitigating safety features or precautions that will be implemented during the flight operation to ensure the safety of the flight operation. A safety case may be submitted to any regulator or controller of airspace to indicate that access to the airspace should be permitted.

The devices, systems, and methods described herein may automate data collection needed to prepare a safety case for a drone operation, thereby reducing the time and cost needed to collect such data. Once data is collected, the data may be analyzed to identify hazards and determine risks associated with the hazards. An overall risk may then be determined for a proposed flight operation, which may be included in a safety case. The devices, systems, and methods described herein may also determine an optimal route or flight plan for a drone operation that minimizes risk for the operation while still meeting other user objectives. Once a waiver application is granted, a drone may be monitored by an unmanned traffic management (UTM) system to ensure compliance with waiver limitations.

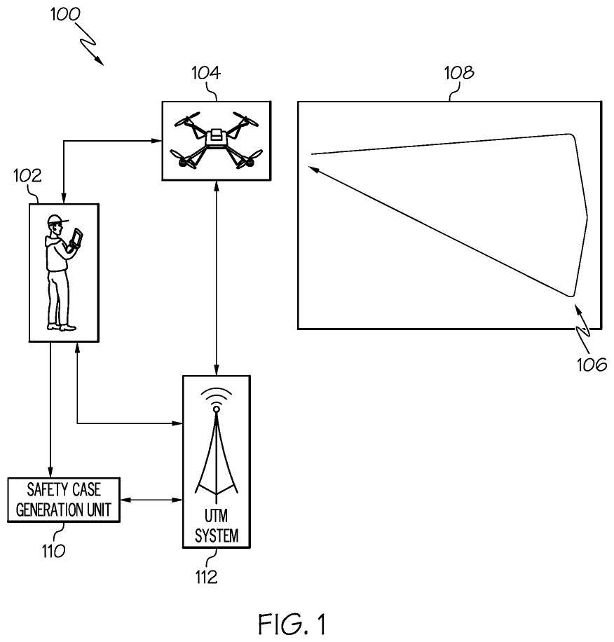

FIG. 1 depicts an example system 100 for conducting flight operation for a drone. In the example of FIG. 1, an operator 102 remotely controls an unmanned aerial vehicle (UAV) 104, such as a drone. In this example, the relevant regulator is the FAA, although in other examples, regulations could be imposed by other regulators, whether official or unofficial. The operator 102 may desire to pilot the drone 104 along a flight path 106 within a geographic area 108. However, FAA regulations limit the operation of drones. Specifically, Part 107 of the Federal Aviation Regulations places certain operational restrictions on drones. For example, drones are not allowed to be flown at night, over people, or outside of a line of sight of the drone operator. There are also limitations on the speed, elevation, and payload of drones. However, many use cases for drones, such as urban air mobility, infrastructure inspection, and package delivery, require operation beyond what is allowed by these FAA regulations.

If the drone operator 102 desires to operate the drone 104 in a manner prohibited by FAA regulations or regulations from another regulator, the operator 102 may apply for a waiver. A waiver application may include a safety case that includes the details of a proposed flight operation, including where the flight operation will take place (e.g., a 3-D volume above a certain geographic area), a window of time during which the flight operation will take place, data about the vehicle and other equipment that will be used for the operation (e.g., performance, certification, reliability, failure modes), and any mitigating safety features or precautions that will be implemented. The safety case may identify all potential hazards in the environment where the drone operation will occur (e.g., telephone poles, trees, population centers on the ground). Risks associated with each hazard may be assessed and any operational procedures that will be implemented to mitigate those risks may be included in the safety case (e.g., special equipment being used, ground based radar monitoring, restricting people from the area).

All of the above information may be compiled in a safety case along with an overall risk of injuring someone during the proposed operation. The safety case may then be submitted to the FAA or other regulator and the regulator may grant the waiver to allow the proposed flight operation under the conditions specified in the waiver application. The overall risk of causing an injury must generally be below a threshold in order for the waiver to be granted.

In order to prepare a safety case, data is typically gathered manually by having one or more people go out into the field in the area where the flight operation is to take place and collect data either visually or with sensors and other equipment. This may be a laborious and expensive process. Furthermore, a safety case is typically developed based on a worst-case scenario. That is, if a particular hazard poses a risk at any time, it must be accounted for in the safety case even if the risk is not present at all times. One way to mitigate such a risk is to only perform the flight operation at times when the risk is not present (e.g., operating a drone at a specific time when the population density in a certain area is low). As such, a safety case may indicate that a particular risk is only present at certain times and/or locations and that the flight operation will only occur at times when the risk is not present or is below a threshold. However, this may require gathering even more data to determine the times and/or locations when risks are not present, which may involve an even greater expense if the data is collected manually.

The present disclosure aims to solve the above problems. Much of the data needed to prepare a safety case is available in public or private databases. Thus, the devices, systems, and methods of the present disclosure access these databases to gather required data for a safety case without the need to visit the site of a proposed flight operation and manually gather data. The data from these databases may then be analyzed to automatically identify hazards and determine risk levels associated with the hazards. The devices, systems, and methods of the present disclosure may also determine particular times and/or locations at which these risks are higher or lower and a proposed flight plan may be determined accordingly.

Once a waiver is granted to allow a particular flight operation under certain conditions, the conditions may be stored by an unmanned traffic management (UTM) system. The UTM system may then monitor a drone operating under such a waiver to ensure that the required conditions or flight limitations are met. Although the present disclosure is directed toward preparing a safety case to be used in an application to the FAA seeking a waiver to Part 107 of the Federal Aviation Regulations, in other examples, the devices, systems, and methods disclosed herein may be used to prepare a safety case for other applications and/or regulators.

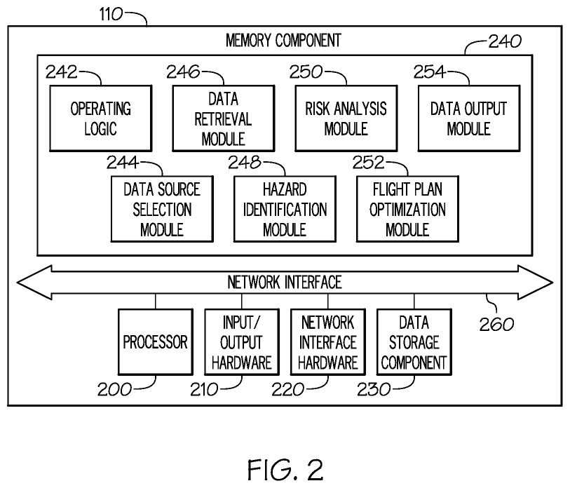

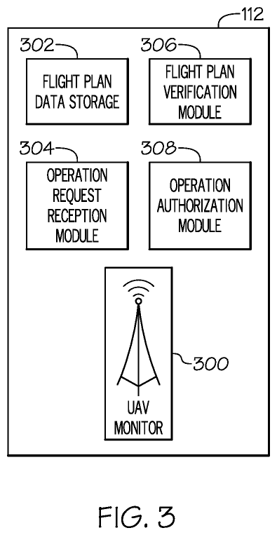

Referring still to FIG. 1, the system 100 may include a safety case generation unit 110 and a UTM system 112. The safety case generation unit 110 may collect data and generate a safety case, as discussed below in connection with FIG. 2. The UTM system 112 may manage UAV traffic and may monitor UAVs operating under a waiver to enforce any waiver conditions, as discussed below in connection with FIG. 3.

Now referring to FIG. 2, the components of the safety case generation unit 110 are schematically depicted. In the illustrated example, the safety case generation unit 110 is a server computing device. However, in other examples, the safety case generation unit 110 may be any type of computing device (e.g., mobile computing device, personal computer, etc.). Additionally, while the safety case generation unit 110 is depicted in FIG. 2 as a single piece of hardware, this is also merely an example. More specifically, the safety case generation unit 110 may represent a plurality of computers, servers, databases, etc. In some examples, the safety case generation unit 110 may be configured as a general purpose computer with the requisite hardware, software, and/or firmware. In other examples, the safety case generation unit 110 may be configured as a collection of cooperating computing devices or even as a special purpose computer designed specifically for performing the functionality described herein.

As illustrated in FIG. 2, the safety case generation unit 110 may include a processor 200, input/output hardware 210, network interface hardware 220, a data storage component 230, and a non-transitory memory component 240. The memory component 240 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 240 may be configured to store operating logic 242, a data source selection module 244, a data retrieval module 246, a hazard identification module 248, a risk analysis module 250, a flight plan optimization module 252, and a data output module 254 (each of which may be embodied as a computer program, firmware, or hardware, as an example). A network interface 260 is also included in FIG. 2 and may be implemented as a bus or other interface to facilitate communication among the components of the safety case generation unit 110.

The processor 200 may include any processing component configured to receive and execute instructions (such as from the data storage component 230 and/or the memory component 240). The input/output hardware 210 may include a monitor, keyboard, mouse, printer, camera, microphone, speaker, touch-screen, and/or other device for receiving, sending, and/or presenting data. The network interface hardware 220 may include any wired or wireless networking hardware, such as a modem, LAN port, wireless fidelity (Wi-Fi) card, WiMax card, mobile communications hardware, and/or other hardware for communicating with other networks and/or devices.

The data storage component 230 may store information about databases or data sources that contain information that may be used when preparing a safety case. The data sources identified in the data storage component 230 may include government databases, other public databases, private databases, or any combination thereof. In embodiments, the data sources identified in the data storage component 230 may be accessed remotely (e.g., over the Internet). The information about data sources identified in the data storage component 230 may include a location (e.g., a URL) where a data source may be accessed. The information may also include the type of information contained in each such data source. The data storage component 230 may store the information about data sources in a table or other data structure. As such, when a certain type of data is needed, this table or other data structure in the data storage component 230 may identify what data source contains the data and how the data source may be accessed. It should be understood that the data storage component 230 may reside local to and/or remote from the safety case generation unit 110 (e.g., the data storage component 230 may comprise cloud storage).

Included in the memory component 240 are operating logic 242, a data source selection module 244, a data retrieval module 246, a hazard identification module 248, a risk analysis module 250, a flight plan optimization module 252, and a data output module 254. The operating logic 242 may include an operating system and/or other software for managing components of the safety case generation unit 110.

The data source selection module 244 may select one or more data sources identified in the data storage component 230 from which to gather data based on a proposed flight operation. In embodiments, a drone operator may input parameters for a proposed flight operation into the safety case generation unit 110 (e.g., by using the input/output hardware 210). The parameters may include the geographic area in which the proposed flight operation will take place. In addition, any number of additional parameters may also be input by the drone operator including the speed and elevation of the drone during the operation, when the operation will take place (e.g., time of day, day of the week), the equipment to be used during the operation, and the like.

Once the parameters of a proposed flight operation are input to the safety case generation unit 110, the data source selection module 244 may select one or more data sources from the data storage component 230 from which to retrieve data. The data source selection module 244 may select the data sources based on the parameters. The data source selection module 244 may select some data sources in all cases and may select other data sources only in certain cases. For example, some data sources may include data only about certain geographic areas and these data sources need not be used for flight operations that do not involve these areas.

After the data source selection module 244 selects one or more data sources from the data storage component 230, the data retrieval module 246 may retrieve data from the selected data sources. Each identified data source may provide a different type of data that may be used in a safety case. For example, population data may be retrieved from the Census Bureau, power line locations may be retrieved from power plants, stadiums and other obstacles may be retrieved from the FAA, etc. The data source selection module 244 may remotely retrieve data from the identified data sources related to the parameters of the proposed flight operation (e.g., data relating to the geographic area of the proposed flight operation).

The hazard identification module 248 may analyze the data received by the data retrieval module 246 and identify potential hazards within the geographic area of the proposed flight operation. In embodiments, the hazard identification module 248 may identify hazards from a pre-determined list of potential hazards (e.g., population centers, power lines, towers and other obstructions, geographic features such as trees and hills, RF information). These potential hazards may be extracted from the data received by the data retrieval module 246.

After the hazard identification module 248 identifies hazards within the geographic area of the proposed flight operation, the risk analysis module 250 may quantify the effects of the identified hazards on the flight operation. Specifically, the risk analysis module 250 may determine a risk associated with each identified hazard at different times (e.g., risks may vary on different days of the week or at different times of day) and at different locations within the geographic area of the proposed flight operation. The risk analysis module 250 may determine the risks of the identified hazards based on prior risk modeling (e.g., using a rules-based system that quantifies risks for different types of hazards).

In some examples, the risk analysis module 250 determines a quantitative risk associated with hazards (e.g., a probability causing an injury). In other examples, the risk analysis module 250 determines a qualitative risk associated with hazards. In some examples, the risk analysis module 250 utilizes a Specific Operations Risk Assessment (SORA) to determine risk associated with hazards. In some examples, the risk analysis module 250 may consider technical solutions (e.g., equipment to be used during the proposed flight operation) or operational procedures (e.g., visual observation of the drone) that may mitigate risk.

By considering the risk of different hazards dynamically, the risk analysis module 250 may determine risk levels at different times of day, or different days of the week, or using specific routes or flight paths. Thus, a safety case may be tailored to specific conditions when risk is lower, as opposed to considering the worst-case scenario. For example, a flight operation may only occur on certain days of the week or a flight path may be routed around a particular hazard. This is discussed in further detail below in connection with the flight plan optimization module 252.

After dynamically determining the risk of each hazard identified by the hazard identification module 248, the risk analysis module 250 may determine an overall risk of the proposed flight operation. In some examples, the risk analysis module 250 may determine a probability of the flight operation causing an injury. The overall risk may also be determined dynamically. That is, the risk analysis module 250 may determine an overall risk level (e.g., a probability of causing an injury) as a function of a specific route and when the operation takes place.

The flight plan optimization module 252 may determine an optimal flight plan that meets one or more objectives or constraints, based on the risk determined by the risk analysis module 250, as disclosed herein. In order for a waiver to be granted by the FAA or another regulator, the safety plan submitted with a waiver application may be required to show that the level of risk of the proposed flight operation is below a threshold (e.g., the probability of causing an injury during the operation is below a certain level). Thus, the flight plan optimization module 252 may determine a flight plan that ensures the level of risk is below the required threshold. In addition, the flight plan optimization module 252 may consider other user-specified objectives. In some examples, these objectives may be entered by the drone operator or other users through the input/output hardware 210.

In some examples, a waiver may have already been granted by the FAA or another regulator with a particular risk performance threshold. As such, flight plans that meet the risk performance threshold may be allowed under the waiver. In these examples, the flight plan optimization module 252 may determine a flight plan that meets the risk performance threshold specified by a waiver granted by the FAA or another regulator.

A variety of objectives related to a flight operation may be input to the safety case generation unit 110. For example, objectives may include minimizing flight time, fuel consumption, or route length, maximizing surface area observed, or selecting or being close to a preferred departure time. Any other objectives related to a flight operation may also be included.

In one example, a drone operator may enter a single objective to be maximized or minimized. For example, an objective may comprise minimizing flight time or minimizing fuel consumption during a flight operation. The flight plan optimization module 252 may then determine a flight plan (e.g., a route and time of the flight operation) that maximizes or minimizes the objective while still ensuring that the overall risk level of the flight operation is below the required threshold.

In other examples, a drone operator may enter multiple objectives to be maximized or minimized. In these examples, the flight plan optimization module 252 may consider all the specified objectives and may determine a flight plan that maximizes, minimizes, or otherwise optimizes a set of the user-specified objectives while ensuring that the risk of the flight operation is below the required threshold. This may be accomplished by the flight plan optimization module 252 determining all possible flight plans that have a risk level below the required threshold. Then, among the potential flight plans that meet the requisite risk requirement, the flight plan optimization module 252 may select the flight plan that maximizes or minimizes the set of user-specified objectives. In some examples, a drone operator may assign a weight to each objective such that the flight plan optimization module 252 may weight certain objectives more heavily than others when determining a flight plan.

By determining a flight plan based on the dynamic risk assessment performed by the risk analysis module 250, the flight plan optimization module 252 may be able to determine a flight plan that has a risk below the required risk threshold that would not be possible using worst-case scenario analysis. For example, a particular proposed flight operation may involve flying over an area that is often highly populated. Thus, if a safety case simply proposed flying over this area without any restrictions, the risk of injury may be unacceptably high and a waiver may not be granted by the regulator. However, the risk analysis module 250 may determine certain times during the week when the area is not highly populated and the risk of the flight operation at these times may be below the required risk threshold. Thus, the flight plan optimization module 252 may determine a flight plan that takes place at one of these times when the risk is below the threshold. This restriction may be included in a safety case, which may allow the waiver for the flight operation to be granted.

Once, the flight plan optimization module 252 determines a flight plan for the proposed flight operation having a risk below the required threshold, the determined flight plan may be included in a safety case. The safety case may then be submitted in a waiver application to the regulator. Alternatively, in examples where a waiver has been granted allowing flights that meet a certain risk performance threshold, if the flight plan optimization module 252 is able to generate a flight plan that meets the required risk performance threshold specified by the waiver, then the flight operation may be allowed.

The data output module 254 may output data as determined by the flight plan optimization module 252 and/or the risk analysis module 250 in a preferred format. The output may comprise details regarding the risks determined by the risk analysis module 250 and/or the flight plan determined by the flight plan optimization module 252. In some examples, the data output module 254 outputs data using the input/output hardware 210. In other examples, the data output module 254 may transmit data using the network interface hardware 220. The data output module 254 may output data in a variety of formats, such as PDF, Word, JSON, etc.

In some examples, the data output module 254 may transmit data directly to the regulator as part of a safety case and/or waiver application. In these examples, the data output module 254 may format data to be compatible with a submission process for the regulator (e.g., the FAA) for waiver applications. The data output module 254 may output the flight plan determined by the flight plan optimization module 252 along with the risks determined by the risk analysis module 250. In other examples, the data output module 254 may output this data to a user who may compile the data into a safety case and/or a waiver application to be submitted to the regulator.

When a waiver application is submitted to the regulator, the safety case may include mitigation factors that will be undertaken during the proposed flight operation. For example, the safety case may include certain equipment or monitoring procedures that may be used. In addition, the safety case may include a specific route to be followed or specific times that the operation will occur as determined by the flight plan optimization module 252. As such, when the regulator (e.g., the FAA) grants a waiver application, the waiver may specify that the procedures included in the waiver application must be followed. The UTM system 112 of FIG. 1 may enforce these waiver requirements, as discussed below in connection with FIG. 3.

It should be understood that the components illustrated in FIG. 2 are merely illustrative and are not intended to limit the scope of this disclosure. More specifically, while the components in FIG. 2 are illustrated as residing within the safety case generation unit 110, this is a non-limiting example. In some embodiments, one or more of the components may reside external to the safety case generation unit 110.

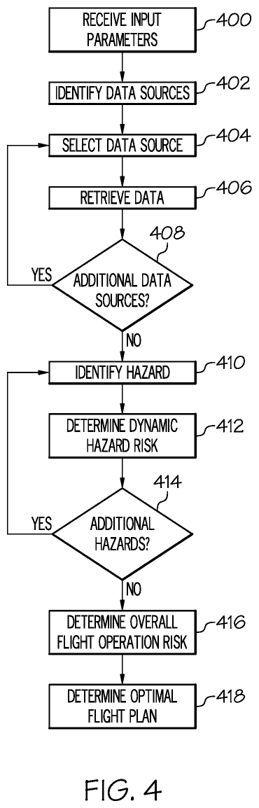

As mentioned above, the various components described with respect to FIG. 2 may be used to carry out one or more processes and/or provide functionality for generating a safety case. An illustrative example of the various processes is described with respect to FIG. 4. Although the steps associated with the blocks of FIG. 4 will be described as being separate tasks, in other embodiments, the blocks may be combined or omitted. Further, while the steps associated with the blocks of FIG. 4 will be described as being performed in a particular order, in other embodiments, the steps may be performed in a different order

Referring back to FIG. 1, the UTM system 112 may monitor UAVs such as the drone 104. In particular, the UTM system 112 may ensure that the drone 104 follows any requirements or limitations to a flight plan specified by a waiver from the FAA or another regulator, as discussed below.

Now referring to FIG. 3, the components of the UTM system 112 are schematically depicted. In the example of FIG. 3, the UTM system 112 comprises a UAV monitor 300. The UAV monitor 300 may monitor UAVs within a certain geographic area. The UAV monitor 300 may track the position of UAVs using radar or other tracking technologies or by receiving positions of UAVs from the UAVs themselves.

The UTM system 112 may further comprise a flight plan data storage 302. The flight plan data storage 302 may store data relating to authorized flight plans for flight operations (e.g., flight plans allowed by an FAA waiver). The flight plan data storage 302 may associate different authorized flight plans with specific UAVs which are authorized to use those flight plans. When a drone is granted a waiver from the FAA or another regulator to perform a particular flight operation, any requirements or operational restrictions in the waiver may be stored in the flight plan data storage 302. For example, a waiver may allow the drone 104 of FIG. 1 to fly a particular route at particular times, as specified in a safety case, as discussed above. Thus, this waiver information for flight operations may be stored in the flight plan data storage 302.

Referring still to FIG. 3, the UTM system 112 may further comprise an operation request reception module 304. The operation request reception module 304 may receive requests from UAVs to perform a flight operation using a particular route. For example, the drone operator 102 may submit a request for the drone 104 to fly along the flight path 106. The request to perform a flight operation may include the route to be flown as well as the time that the route is to be flown if the flight is not to be taken immediately.

Referring still to FIG. 3, the UTM system 112 may further comprise a flight plan verification module 306. After receiving a request for a UAV to perform a flight operation, if the parameters of the flight operation would require a waiver from the FAA or another regulator, the flight plan verification module 306 may access the flight plan data storage 302 to determine whether waiver information is stored for that UAV. If waiver data is associated with that UAV in the flight plan data storage 302, the flight plan verification module 306 may determine whether the requested flight operation is allowed by the waiver associated with the UAV. For example, the flight plan verification module 306 may determine whether the requested route and time of flight is allowed by the waiver associated with the UAV.

If the requested flight operation is authorized by an appropriate waiver, an operation authorization module 308 may transmit an authorization to the UAV operator that submitted the flight operation request. If the requested flight operation is not authorized by an appropriate wavier, the operation authorization module 308 may transmit a denial of authorization to the UAV operator for the requested flight operation.

Referring now to FIG. 4, a flow chart is shown for generating a safety case, according to one or more embodiments shown and described herein. At step 400, the safety case generation unit 110 receives input parameters for a proposed flight operation. The input parameters may include a geographic area over which the operation is to take place. The input parameters may also include other information about the proposed flight operation such as a speed or elevation of the flight, departure and/or landing times, payload, equipment to be used, etc. The input parameters may include features of the proposed flight operation to mitigate risk (e.g., equipment to be used or operational procedures to be followed).

In some examples, the input parameters may include user objectives for the flight operation. This may allow the flight plan optimization module 252 to determine a flight plan that minimizes or maximizes the specified objectives, as discussed above. The user objectives may also include weights associated with the objectives, as discussed above.

At step 402, the data source selection module 244 identifies one or more data sources to gather data from based on the input parameters. The data source selection module 244 may identify data sources from among the data sources stored in the data storage component 230. The data sources may include government databases, other public databases, private databases, or any combination thereof. In embodiments, the selected data sources may be accessed remotely. The data source selection module 244 may also identify a URL or other method of connecting to each of the identified data sources stored in the data storage component 230. The data source selection module 244 may identify data sources that may have information regarding hazards that may be relevant to the proposed flight operation.

At step 404, the data retrieval module 246 selects one of the data sources identified by the data source selection module 244 and establishes a remote connection to that data source. The data retrieval module 246 may utilize the URL or other information stored in the data storage component 230 associated with the data source to establish a remote connection with the data source.

After establishing a connection with the selected data source, at step 406, the data retrieval module 246 downloads data related to the proposed flight operation (e.g., data related to the geographic area of the operation). Each data source identified by the data source selection module 244 may provide a different type of data. The data may include information about hazards located in the geographic area of the proposed flight operation and other information that may be used when preparing a safety case. As this data is downloaded, it may be stored in the data storage component 230.

At step 408, the data retrieval module 246 determines whether there are additional data sources selected by the data source selection module 244 from which to download data. If there are additional data sources to download data from (Yes at step 408), then control returns to step 404 and another data source is selected. This process may continue until the data retrieval module 246 downloads data from all the data sources selected by the data source selection module 244. Alternatively, if data has been downloaded from all the data sources selected by the data source selection module 244 (No at step 408), then control passes to step 410.

At step 410, the hazard identification module 248 identifies a hazard present in the geographic area of the proposed flight operation based on the data received by the data retrieval module 246. A hazard may include a population center, a power line, a tower, geographic hazards such as trees and hills, and the like. The hazard identification module 248 may extract information about the hazard from the data received by the data retrieval module 246 and stored in the data storage component 230. In some embodiments, the hazard identification module 248 may identify hazards from a predetermined list of potential hazards.

At step 412, the risk analysis module 250 dynamically quantifies a risk associated with the hazard identified by the hazard identification module 248. In particular, the risk analysis module 250 may determine a risk associated with the hazard based on a time and flight plan of the proposed flight operation. In some examples, the risk analysis module 250 determines a quantitative risk associated with the identified hazard, such as a probability that the hazard will cause an injury. In other examples, the risk analysis module 250 determines a quantitative risk associated with the identified hazard. When quantifying the risk associated with the identified hazard, the risk analysis module 250 may consider factors that mitigate risk included in the input parameters.

At step 414, the risk analysis module 250 determines whether there are additional hazards identified by the hazard identification module 248 that have yet to be analyzed by the risk analysis module 250. If there are additional hazards to analyze (Yes at step 414), then control returns to step 410. This process may continue until all of the hazards identified by the hazard identification module 248 have been analyzed by the risk analysis module 250. Alternatively, if all of the identified hazards have been analyzed by the risk analysis module 250, then, at step 416, the risk analysis module 250 determines an overall risk for the proposed flight operation based on the risk determined for each identified hazard. This risk may also be determined dynamically (e.g., based on a route and time of the flight operation). In some examples, the overall risk for the proposed flight operation comprises a probability of injuring somebody during the operation.

At step 418, the flight plan optimization module 252 determines an optimal flight plan. The optimal flight plan may be determined based on the dynamic risk determined by the risk analysis module 250 and the user preferences for the flight operation input to the safety case generation unit 110. In one example, the flight plan optimization module 252 determines a flight plan (e.g., a route and time for the proposed flight operation) that maximizes the user preferences while ensuring that the risk for the flight operation remains below a predetermined threshold.

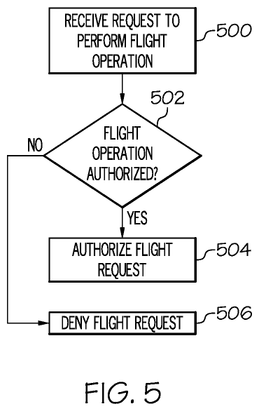

Referring now to FIG. 5, a flow chart is shown for a method of monitoring a UAV that may be performed by the UTM system 112, according to one or more embodiments shown and described herein. At step 500, the operation request reception module 304 receives a request from a UAV operator to perform a flight operation. The request to perform the flight operation may include information about the flight operation including a route to be flown and a time that the route is to be flown. The request may also include other information about the flight operation such as equipment to be used or operational procedures to be followed.

At step 502, the flight plan verification module 306 determines whether the requested flight operation is authorized. As disclosed herein, FAA or other regulations may limit the types of flight operations that UAVs are allowed to perform without a waiver. As such, UAV operators may request waivers from the FAA or another regulator to perform additional flight operations not normally allowed. When a waiver is granted for a particular flight operation, the details of the waiver may be stored in the flight plan data storage 302. This may include any conditions associated with the waiver. The conditions associated with the waiver may include information about the types of flight operations that are allowed under the waiver (e.g., permissible days and times of the operation, permissible routes and elevations, required equipment and operational procedures, etc.).

As such, when the operation request reception module 304 receives a request from a UAV operator to perform a flight operation, if the requested flight operation requires a waiver (e.g., it includes operations prohibited by FAA regulations without a waiver), the flight plan verification module 306 may access the flight plan data storage 302 and determine whether a waiver has been granted for the UAV associated with the requested flight operation. If a waiver has been granted, the flight plan verification module 306 may determine whether the parameters of the requested flight operation are allowed under the conditions of the waiver. If the parameters of the requested flight operation are allowed under the conditions of the waiver, or if the particular flight operation does not require a waiver, then the flight plan verification module 306 may determine that the flight operation is authorized. However, if the particular flight operation requires a waiver and either no waiver exists or the parameters of the requested flight operation are not allowed under the conditions of the waiver, then the flight plan verification module 306 may determine that the flight operation is not authorized.

If the flight plan verification module 306 determines that the flight operation is authorized (Yes at step 502), then, at step 504, the operation authorization module 308 may transmit an authorization to the UAV operator that submitted the flight operation request. Alternatively, if the flight plan verification module 306 determines that the flight operation is not authorized (No at step 502), then, at step 506, the operation authorization module 308 may transmit a denial of authorization to the UAV operator. It should now be understood that the devices, systems, and methods described herein gather data for preparing a safety case for a flight operation, identify potential hazards that may be encountered during the flight operation, determine risks of the identified hazards, and determine a flight plan to minimize risk or to maximize user objectives while ensuring that the risk is below a threshold.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

Further aspects of the invention are provided by the subject matter of the following clauses.

A method of determining a flight plan for an unmanned aerial vehicle comprising, with a computing device, receiving a set of parameters associated with a proposed flight operation related to the unmanned aerial vehicle, identifying one or more data sources that contain data associated with one or more of the parameters, retrieving data associated with one or more of the parameters from one or more of the identified data sources, determining a level of risk associated with the proposed flight operation based on the retrieved data, and determining the flight plan based on the level of risk.

The method of any preceding clause, wherein the parameters associated with the proposed flight operation comprise a three-dimensional volume of space above a geographic area within which the proposed flight operation will occur.

The method of any preceding clause, wherein the parameters associated with the proposed flight operation further comprise a window of time during which the proposed flight operation will occur.

The method of any preceding clause, wherein the level of risk comprises a probability of the proposed flight operation causing an injury.

The method of any preceding clause, further comprising identifying one or more hazards within the geographic area based on the retrieved data, and determining a level of risk associated with each identified hazard.

The method of any preceding clause, further comprising dynamically determining the level of risk associated with the proposed flight operation as a function of a route of the proposed flight operation and a time that the proposed flight operation occurs.

The method of any preceding clause, further comprising determining the flight plan comprising a route for the proposed flight operation and a time for the proposed flight operation, wherein the flight plan minimizes the level of risk associated with the proposed flight operation.

The method of any preceding clause, further comprising receiving a user objective associated with the proposed flight operation, and determining the flight plan comprising a route for the proposed flight operation and a time for the proposed flight operation, wherein the flight plan maximizes the user objective such that the risk associated with the flight plan is below a predetermined threshold.

The method of any preceding clause, further comprising receiving a user objective associated with the proposed flight operation, and determining the flight plan comprising a route for the proposed flight operation and a time for the proposed flight operation, wherein the flight plan minimizes the user objective such that the risk associated with the flight plan is below a predetermined threshold.

The method of any preceding clause, further comprising receiving a plurality of user objectives associated with the proposed flight operation, and determining the flight plan comprising a route for the proposed flight operation and a time for the proposed flight operation, wherein the flight plan optimizes the plurality of user objectives such that the risk associated with the flight plan is below a predetermined threshold.

The method of any preceding clause, further comprising receiving a set of weights associated with the user objectives, wherein the flight plan optimizes the plurality of user objectives based on the weights.

A remote computing device comprising one or more processors, one or more memory modules, and machine-readable instructions stored in the one or more memory modules that, when executed by the one or more processors, cause the remote computing device to receive a set of parameters associated with a proposed flight operation related to an unmanned aerial vehicle, identify one or more data sources that contain data associated with one or more of the parameters, retrieve data associated with one or more of the parameters from one or more of the identified data sources, determine a level of risk associated with the proposed flight operation based on the retrieved data, and determine a flight plan for the unmanned aerial vehicle based on the level of risk.

The remote computing device of any preceding clause, wherein the machine-readable instructions stored in the one or more memory modules, when executed by the one or more processors, cause the remote computing device to identify one or more hazards within a geographic area associated with the proposed flight operation based on the retrieved data, and determine a level of risk associated with each identified hazard.

The remote computing device of any preceding clause, wherein the machine-readable instructions stored in the one or more memory modules, when executed by the one or more processors, cause the remote computing device to dynamically determine a level of risk associated with the proposed flight operation as a function of a route of the proposed flight operation and a time that the proposed flight operation occurs.

The remote computing device of any preceding clause, wherein the machine-readable instructions stored in the one or more memory modules, when executed by the one or more processors, cause the remote computing device to receive a plurality of user objectives associated with the proposed flight operation, and determine the flight plan comprising a route for the proposed flight operation and a time for the proposed flight operation, wherein the flight plan optimizes the plurality of user objectives such that the risk associated with the flight plan is below a predetermined threshold.

The remote computing device of any preceding clause, wherein the machine-readable instructions stored in the one or more memory modules, when executed by the one or more processors, cause the remote computing device to receive a set of weights associated with the objectives, wherein the flight plan optimizes the plurality of user objectives based on the weights.

A system comprising a safety case generation unit configured to receive a set of parameters associated with a proposed flight operation for an aerial vehicle, identify one or more data sources that contain data associated with one or more of the parameters, retrieve data associated with one or more of the parameters from one or more of the identified data sources, determine a level of risk associated with the proposed flight operation based on the retrieved data, and determine a flight plan for the aerial vehicle based on the level of risk, and a traffic management system configured to monitor the aerial vehicle.

The system of any preceding clause, wherein the flight plan comprises limitations on the operation of the aerial vehicle, and the traffic management system ensures that the aerial vehicle complies with the limitations.

The system of any preceding clause, wherein the traffic management system is configured to receive a request for the aerial vehicle to perform a flight operation, determine whether the flight operation complies with the limitations of the flight plan, and when the flight operation complies with the limitations of the flight plan, authorize the flight operation.

The system of any preceding clause, wherein the traffic management system is configured to receive a request for the aerial vehicle to perform a flight operation; determine whether the flight operation complies with the limitations of the flight plan; and when the flight operation does not comply with the limitations of the flight plan, deny authorization of the flight operation.

What is claimed is:

1. A method of determining a flight plan for an unmanned aerial vehicle, the method comprising:
with a computing device, receiving a set of parameters associated with a proposed flight operation related to the unmanned aerial vehicle;
identifying one or more data sources that contain data associated with one or more of the parameters;
retrieving data associated with one or more of the parameters from one or more of the identified data sources;
determining a level of risk associated with the proposed flight operation based on the retrieved data, and
determining the flight plan based on the level of risk.

2. The method of claim 1, wherein the parameters associated with the proposed flight operation comprise a three-dimensional volume of space above a geographic area within which the proposed flight operation will occur.

3. The method of claim 2, wherein the parameters associated with the proposed flight operation further comprise a window of time during which the proposed flight operation will occur.

4. The method of claim 1, wherein the level of risk comprises a probability of the proposed flight operation causing an injury.

5. The method of claim 2, further comprising:
identifying one or more hazards within the geographic area based on the retrieved data; and
determining a level of risk associated with each identified hazard.

6. The method of claim 1, further comprising dynamically determining the level of risk associated with the proposed flight operation as a function of a route of the proposed flight operation and a time that the proposed flight operation occurs.

7. The method of claim 6, further comprising determining the flight plan comprising a route for the proposed flight operation and a time for the proposed flight operation, wherein the flight plan minimizes the level of risk associated with the proposed flight operation.

8. The method of claim 6, further comprising:
receiving a user objective associated with the proposed flight operation; and
determining the flight plan comprising a route for the proposed flight operation and a time for the proposed flight operation, wherein the flight plan maximizes the user objective such that the risk associated with the flight plan is below a predetermined threshold.

9. The method of claim 6, further comprising:
receiving a user objective associated with the proposed flight operation; and
determining the flight plan comprising a route for the proposed flight operation and a time for the proposed flight operation, wherein the flight plan minimizes the user objective such that the risk associated with the flight plan is below a predetermined threshold.

10. The method of claim 6, further comprising:
receiving a plurality of user objectives associated with the proposed flight operation; and
determining the flight plan comprising a route for the proposed flight operation and a time for the proposed flight operation, wherein the flight plan optimizes the plurality of user objectives such that the risk associated with the flight plan is below a predetermined threshold.

11. The method of claim 10, further comprising:
receiving a set of weights associated with the user objectives, wherein the flight plan optimizes the plurality of user objectives based on the weights.

12. A remote computing device comprising:
one or more processors;
one or more memory modules; and
machine-readable instructions stored in the one or more memory modules that, when executed by the one or more processors, cause the remote computing device to:
receive a set of parameters associated with a proposed flight operation related to an unmanned aerial vehicle;
identify one or more data sources that contain data associated with one or more of the parameters;
retrieve data associated with one or more of the parameters from one or more of the identified data sources;
determine a level of risk associated with the proposed flight operation based on the retrieved data; and
determine a flight plan for the unmanned aerial vehicle based on the level of risk.

13. The remote computing device of claim 12, wherein the machine-readable instructions stored in the one or more memory modules, when executed by the one or more processors, cause the remote computing device to:
identify one or more hazards within a geographic area associated with the proposed flight operation based on the retrieved data; and
determine a level of risk associated with each identified hazard.

14. The remote computing device of claim 12, wherein the machine-readable instructions stored in the one or more memory modules, when executed by the one or more processors, cause the remote computing device to dynamically determine a level of risk associated with the proposed flight operation as a function of a route of the proposed flight operation and a time that the proposed flight operation occurs.

15. The remote computing device of claim 14, wherein the machine-readable instructions stored in the one or more memory modules, when executed by the one or more processors, cause the remote computing device to:
receive a plurality of user objectives associated with the proposed flight operation; and
determine the flight plan comprising a route for the proposed flight operation and a time for the proposed flight operation, wherein the flight plan optimizes the plurality of user objectives such that the risk associated with the flight plan is below a predetermined threshold.

16. The remote computing device of claim 15, wherein the machine-readable instructions stored in the one or more memory modules, when executed by the one or more processors, cause the remote computing device to:
receive a set of weights associated with the objectives, wherein the flight plan optimizes the plurality of user objectives based on the weights.

17. A system comprising:
a safety case generation unit configured to:
receive a set of parameters associated with a proposed flight operation for an aerial vehicle;
identify one or more data sources that contain data associated with one or more of the parameters;
retrieve data associated with one or more of the parameters from one or more of the identified data sources;
determine a level of risk associated with the proposed flight operation based on the retrieved data; and
determine a flight plan for the aerial vehicle based on the level of risk; and
a traffic management system configured to monitor the aerial vehicle.

18. The system of claim 17, wherein:
the flight plan comprises limitations on the operation of the aerial vehicle; and
the traffic management system ensures that the aerial vehicle complies with the limitations.

19. The system of claim 18, wherein the traffic management system is configured to:
receive a request for the aerial vehicle to perform a flight operation;
determine whether the flight operation complies with the limitations of the flight plan; and
when the flight operation complies with the limitations of the flight plan, authorize the flight operation.

20. The system of claim 18, wherein the traffic management system is configured to:
receive a request for the aerial vehicle to perform a flight operation;
determine whether the flight operation complies with the limitations of the flight plan; and
when the flight operation does not comply with the limitations of the flight plan, deny authorization of the flight operation.
